(19) United States
(12) Patent Application Publication
(10) Pub. No.: US 2018/0349954 A1
(43) Pub. Date: Dec. 6, 2018

(54) OPTIMIZING NOTIFICATION TRIGGERS FOR GEO-FENCE COMMUNICATION SYSTEMS

(71) Applicant: Adobe Systems Incorporated, San Jose, CA (US)

(72) Inventors: Sanket Vaibhav Mehta, Pune (IN); Payal Bajaj, Stanford, CA (US); Ankur Garg, Chandigarh (IN); Sunav Choudhary, Bokaro Steel City (IN)

(21) Appl. No.: 15/615,124

(22) Filed: Jun. 6, 2017

(51) Int. Cl. G06Q 30/02; H04W 4/02; H04L 29/08; H04W 4/08

(52) U.S. Cl. CPC G06Q 30/0261; H04W 4/021; G06Q 30/0267; G06Q 30/0254; H04W 4/08; H04L 67/26

(57) ABSTRACT

Rules for triggering geo-notifications, such as push notifications to a mobile computing device based on its location, are automatically generated based on a user's location, dwell time, and browsing activity. In some embodiments, a geo-fence communication system determines an average dwell time for a group of users in a user segment. The average dwell time indicates an average time for each user to respond to a geo-notification for a product, within a geo-fence. The geo-fence communication system generates a rule for the user segment/product/geo-fence tuple based on the average dwell time. In some cases, semantic similarities between geo-fence locations are determined, and a rule for a geo-fence is generated based on average dwell times for other geo-fences in similar locations.

### TECHNICAL FIELD

This disclosure relates generally to telecommunications systems that monitor the position of mobile computing devices and communicate location-specific information to the mobile computing devices. More specifically, but not by way of limitation, this disclosure relates to optimizing notification triggers that control how geo-fence communication systems transmit user-specific notifications within geo-fences.

### BACKGROUND

Geo-fence communication systems are used for determining whether a mobile computing device is located within a specified geographical boundary (i.e., a “geo-fence”) and, based on detecting the presence of a mobile computing device within the geo-fence, to generate and transmit location-specific messages to the mobile computing device. For example, geo-fencing facilitates transmission of location-based notifications to users that allow the users to utilize certain services available within the geo-fence. Multiple geo-fences may be defined within an area, some of which may overlap. For example, if notifications are to be transmitted to mobile computing devices within a geo-fence on behalf of a certain entity, that entity (e.g., a service provider or a marketer operating on behalf of the provided service) determines a geographic area of a city (e.g., Rodeo Drive in Hollywood) and identifies key locations (e.g., retail stores) within that area to promote. The geo-fences are manually specified using a radius around each of the key locations to define the boundaries of the geo-fences. If a mobile computing device associated with a user enters, exits, or dwells for a specified period within a geo-fence, a notification transmission device wireless transmits an electronic message to the user's mobile computing device (e.g., a notification related to a product offered at or near the key location).

However, suboptimal design and control of geo-fence communication systems can increase the wireless communication in a particular area without any concomitant benefit to the entity using the geo-fencing system. Existing geo-fencing communications lack certain features (e.g., analysis of the histories of mobile computing devices, usage, and transmission patterns for similarly situated locations) that would allow notifications to generated and transmitted in a personalized manner. Therefore, since the geo-fence communication systems are triggered based solely on the entry, exit, or dwell time of any mobile computing device, these systems require additional communication resources (e.g., frequency bandwidth, time slots, etc.) and computing resources (e.g., processing cycles, memory, etc.) for communicating with mobile computing devices via these geo-fences. These and other resources (e.g., financial resources) are therefore expended on monitoring the geo-fences, constructing the targeted messages, and transmitting the target messages based on the volume of users entering the geo-fences, regardless of whether a particular message is likely to be relevant to a particular user. Thus, at least some of these resources are, in effect, wasted on low-affinity recipients.

Present solutions to the lack of personalization of geo-notifications include manually designed triggering rules. However, given a very large number of geo-fences, users, and products featured in geo-notifications, it is prohibitive to manually create triggering rules for all possible combinations of geo-fences, users, and products. In addition, manual creation of triggering rules is prone to errors introduced by cognitive biases. For example, a person creating a triggering rule may create the rule based on his or her beliefs about what users require, rather than the actual behavior of such users. Attempts to implement data-driven personalization are hampered by data sparsity. For example, the number of available geo-fences may be quite large compared to the number of geo-fences visited by a given user. Sparsity of data for geo-fences may result in triggering rules that are not based on quantitative data.

### SUMMARY

According to certain embodiments, a user of a mobile computing device within a geo-fence performs content interactions with online product content after a dwell time. The dwell time indicates a duration until the mobile computing device sends a response to a geo-notification, or until the mobile computing device browses to the online product content. A trigger notification rule for a user segment is generated or modified based on data describing content interactions by a multiple mobile computing devices with a particular product within a particular geo-fence. The trigger notification rule indicates an optimal dwell time for geo-notifications sent to the user segment, for the particular product and geo-fence. Based on data describing content interactions for multiple users, an average dwell time is determined for the particular geo-fence. The optimal dwell time is based on the average dwell time for the particular geo-fence. Additionally or alternatively, the optimal dwell time is based on aggregated average dwell times for additional geo-fences, based on similarities between the particular and the additional geo-fences.

These illustrative embodiments are mentioned not to limit or define the disclosure, but to provide examples to aid understanding thereof. Additional embodiments are discussed in the Detailed Description, and further description is provided there.

Features, embodiments, and advantages of the present disclosure are better understood when the following Detailed Description is read with reference to the accompanying drawings, where:

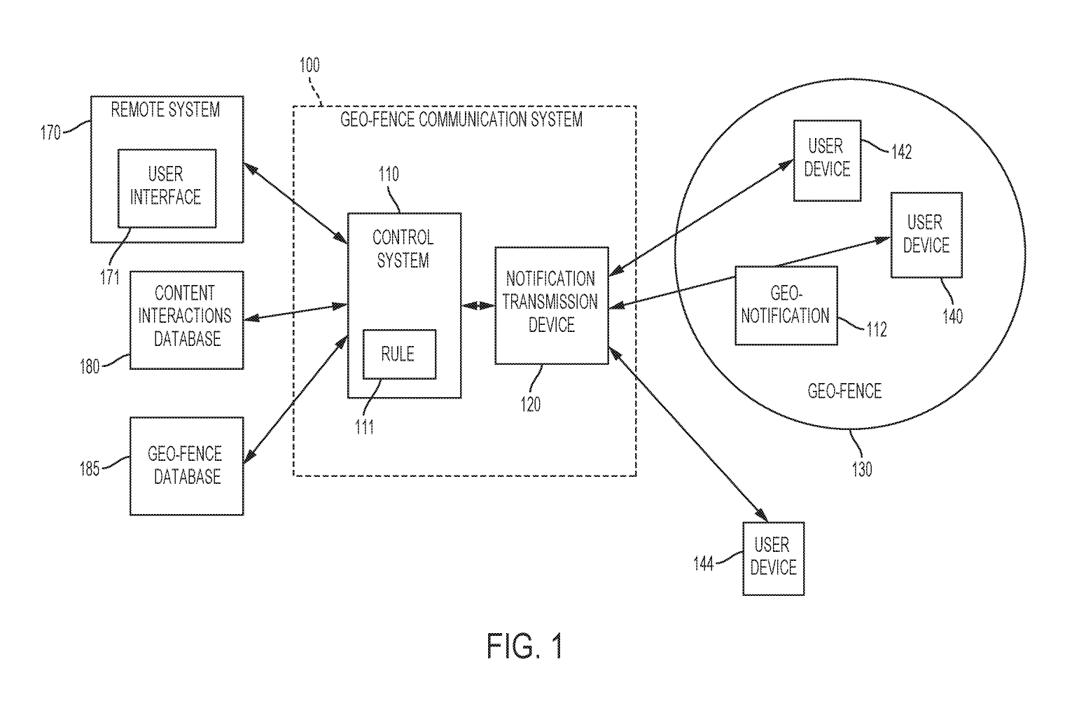

FIG. 1 is a block diagram depicting an example of a geo-fence communication system, according to certain embodiments;

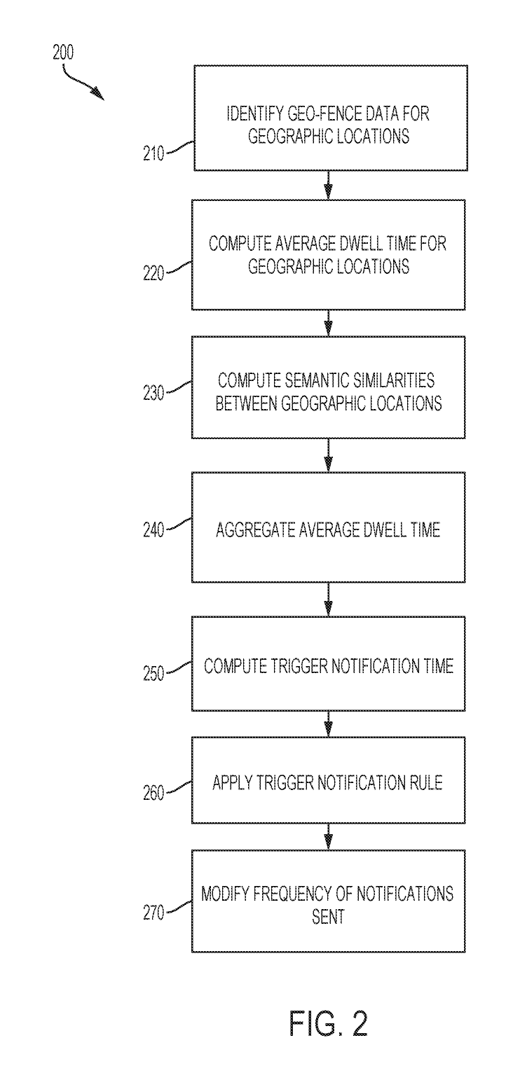

FIG. 2 is a flow chart depicting an example process for modifying how frequently geo-notifications are transmitted to user devices within a geo-fence, according to certain embodiments;

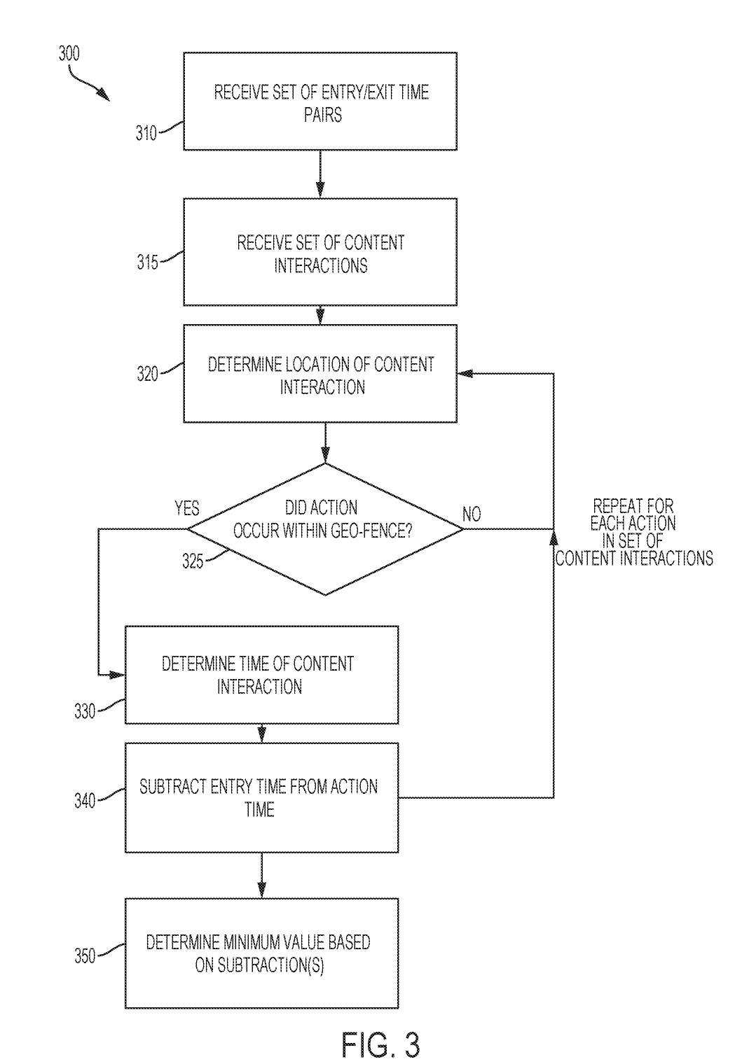

FIG. 3 is a flowchart depicting an example of a process for determining a minimum elapsed dwell time for a user device responding to geo-notifications, according to certain embodiments;

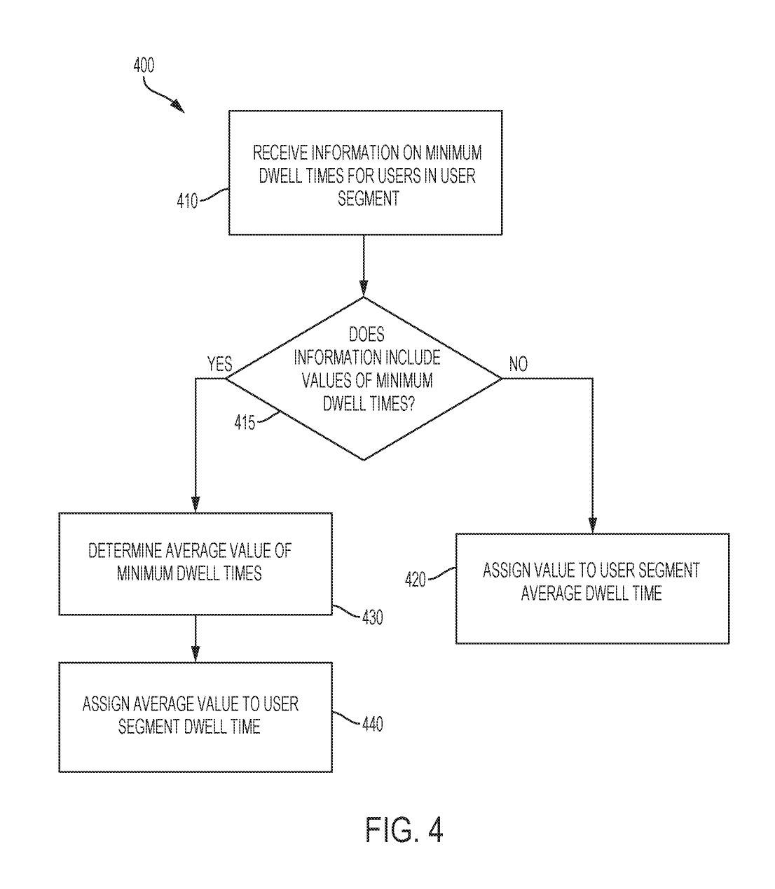

FIG. 4 is a flow chart depicting an example process for determining an average dwell time for a user segment, according to certain embodiments;

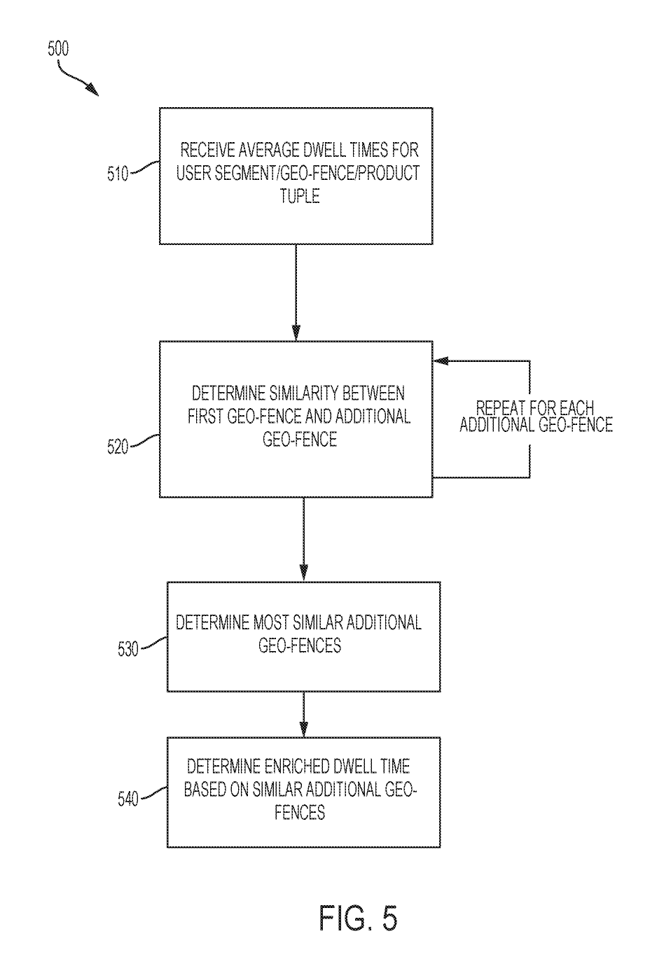

FIG. 5 is a flow chart depicting an example process for determining an enriched dwell time for a user segment, according to certain embodiments;

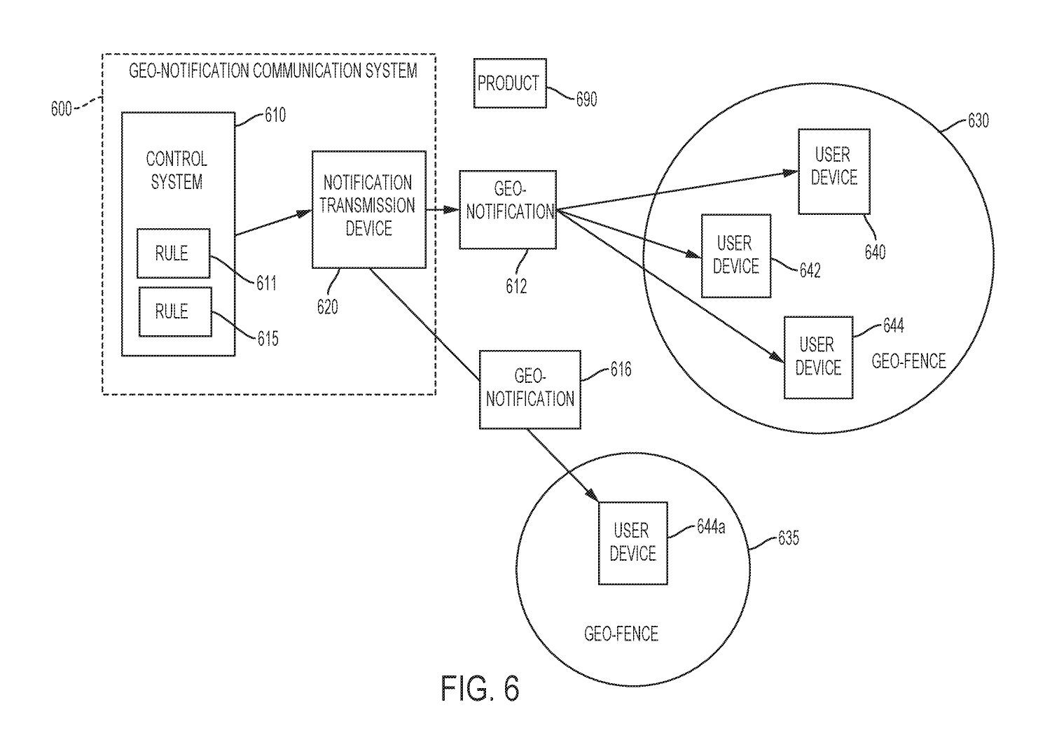

FIG. 6 is a block diagram depicting an example of a geo-fence communication system capable of determining trigger notification rules based on semantic similarities between geo-fences, according to certain embodiments;

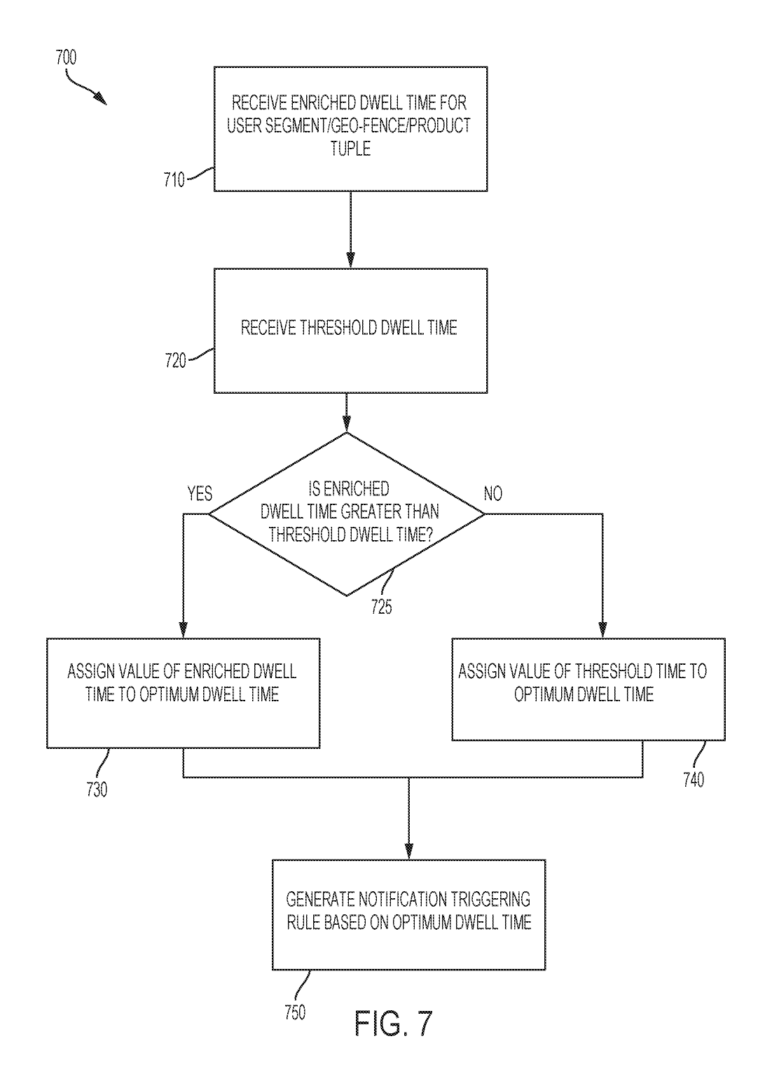

FIG. 7 is a flow chart depicting an example process for generating a trigger notification rule for a user segment/geo-fence/product tuple, based on an enriched dwell time, according to certain embodiments;

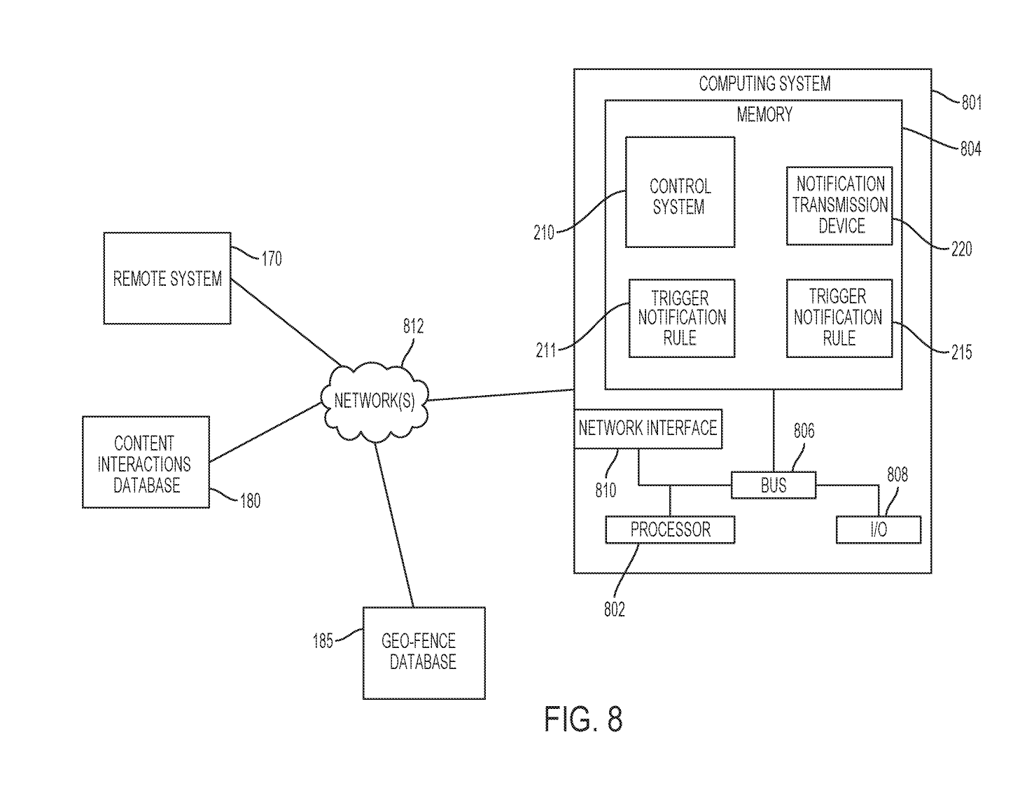

FIG. 8 is a block diagram depicting an example of a computing system for implementing a geo-fence communication system, according to certain embodiments.

### DETAILED DESCRIPTION

Embodiments described herein provide an optimized notification-triggering scheme that cause geo-fence communication systems to transmit targeted, user-specific notifications to mobile computing devices that are detected within or near geo-fences. The notification-triggering scheme is automatically developed based on models of user interactions with online content within geo-fences and user devices' dwell time within geo-fences. The notification-triggering scheme restricts the transmission of location-specific notifications within geo-fences to particular user devices and particular time frames that are more likely to result in responsive interactions by user devices (e.g., browsing online content accessible via the notifications), thereby optimizing the use of computing resources, network resources, and other resources.

The following non-limiting example is provided to introduce certain embodiments. In this example, a geo-fence communication system, which includes one or more control servers and multiple notification transmission devices, is used to optimize a triggering process that causes the notification transmission devices to communicate location-specific notifications to mobile computing devices that are detected within geo-fences. The control server obtains and analyzes historical geo-fence data for one or more user segments. Geo-fence data includes, for example, records describing sequences of electronic interactions with online product content via mobile computing devices, where the electronic interactions occurred within geo-fences that service various geographic locations. Based on the analysis of the historical geo-fence data, the control server generates or modifies an intelligent triggering scheme that controls how frequently one or more of the notification transmission devices transmits notifications within the geo-fences. The intelligent triggering scheme accounts for attributes of users or their associated mobile computing devices, such as dwell times of mobile computing devices within certain geo-fences, user devices' activity with respect to certain types of geographic locations, the propensity of certain types of user devices for certain types of online content or services accessible via geo-fence notifications, etc.

To generate the intelligent triggering scheme, the control server determines one or more optimal trigger notification times based on historical dwell time data that is aggregated across semantically similar locations. A dwell time includes, for example, a response time that is a duration until a mobile computing device transmits a response to a notification (e.g., clicking a link in a geo-notification or otherwise interacting with online content via a geo-notification) within one of the geo-fences that identifies the online product content, a browsing duration until the mobile computing device is used to interact within online product content within one of the geo-fences, etc. For a particular segment of user devices, the control server computes an average dwell time of user devices within each geo-fence.

The control server aggregates these individual dwell time computations to address problems of data sparsity. Since the number of different locations in an area are generally quite large as compared to the number of locations visited by a single user device, the intelligent triggering scheme accounts for the absence of observations at a given location by aggregating data from semantically similar locations. A semantic similarity between a pair of geographic locations is computed based on a corresponding pair of semantic vectors for the geographic locations, where each semantic vector includes dimensions representing types of places located within a threshold distance of a respective geographic location. For instance, a semantic vector could represent a certain combination of restaurants, hospitals, police stations, etc. within a certain distance of a geo-fence. The control server aggregates the average dwell time data for the geographic locations having a sufficient semantic similarity. The control server computes an optimal trigger notification time for the set of semantically similar locations, where the optimal trigger notification time is generated the aggregated dwell time data for the user segment across the set of locations.

The control server develops an intelligent triggering scheme, which includes one or more trigger notification rules, based on this optimal trigger notification time. Applying the trigger notification rules causes notification transmission devices to transmit geo-notifications to mobile computing devices using the optimal trigger notification time. When the intelligent triggering scheme is used, notification transmissions are limited to mobile computing devices associated with the user segment to which the trigger notification rule applies, thereby focusing network and computing resources on mobile computing devices whose users are more likely to perform some action in response to the geo-notifications.

As used herein, the terms “geographic fence” and “geo-fence” refer to a geographic area or location that is encompassed by a boundary. A geo-fence is represented, for example, as a region defined on a computer-accessible map. In some cases, the boundary is virtual, such as a boundary having little or no physical representation. Additionally or alternatively, a geo-fence is defined by a radius from a point, a set of points (e.g., coordinates), a set of straight or curved sides (e.g., borders of an area), or any other appropriate shape or defining feature set. In some cases, geo-fences include points of interest, such as a landmark, a building (e.g., hospital, retail store), a virtual point (e.g., a marker in an online game), or any other suitable point of interest.

As used herein, the term “user device” refers to a mobile computing device and the entity that uses the mobile computing device. The mobile computing device includes a smart phone, a mobile phone, a tablet computing device, or any other suitable mobile device. The entity that uses the mobile computing device includes, for example a person, a group of people (e.g., family members), a business, or any other suitable entity. In some cases, the user device identifies a current location, such as by a global positioning system (e.g., GPS) or other system for determining location.

As used herein, the term “user segment” refers to a group of user devices having related attributes. For example, a user segment includes one or more user devices having similar attributes of demographic information, income, and spending habits. In some cases, a group of user devices is assigned to one or more user segments such that each particular user device is included in only one of the user segment.

As used herein, the term “geo-notification” refers to an electronic notification that is provided to one or more user devices. In some cases, the geo-notification is transmitted by a geo-fence communication system. The transmitted geo-notification includes or references content, such as online product content. For example, a geo-notification includes a computer-accessible code, such as coupon code related to an online offer. Additionally or alternatively, the geo-notification includes a reference to online product content, such as a link to a website. In some cases, the geo-notification includes content that is used in a physical context (e.g., “offline”), such as a coupon code that is provided to a salesperson in a spoken conversation.

In some cases, a response to a geo-notification includes one or more actions by the user device. The actions include, for example, replying to a geo-notification (e.g., a message sent via an application, browsing to referenced content). In some cases, responses are transmitted in real time or substantially real time, such that no delay is perceptible to a user device. Additionally or alternatively, responses or related information are stored on the mobile computing device, and transmitted at a later time, such as upon a synchronization between the mobile computing device and a computing system (e.g., a server) associated with a geo-fence communication system.

As used herein, the term “geo-fence communication system” refers to a system of one or more computing devices that generates and transmits a geo-notification to a user device. A geo-fence communication system is associated with one or more geo-fences. Additionally or alternatively, the geo-fence communication system is associated with one or more products. In some cases, the geo-fence communication system is associated with an operator, such as a business that provides geo-notifications to customers (or potential customers).

In some cases, the geo-fence communication system is associated with one or more geo-fences. A geo-fence communication system provides geo-notifications, such as a geo-notification sent to a user device. In some cases, a geo-fence communication system includes (or has access to) multiple computing systems, such as a notification control system, a notification transmission system, a database of geo-fences, and activity or content interaction database, or other suitable systems.

As used herein, the term “trigger notification time” refers to a period of time between a user device entering the geo-fence and a geo-notification being provided to the user device. In some cases, the trigger notification time is included in a trigger notification rule For example,

As used herein, the term “trigger notification rule” refers to information that indicates circumstances by which a geo-notification is sent to a user device. In some cases, trigger notification rule includes a trigger notification time, which refers to a period of time between the user device entering a geo-fence and a geo-notification being provided to the user device. A trigger notification rule is generated or modified, for example, by a geo-fence communication system. In some cases, a geo-fence dedication system applies a trigger notification rule to one or more geo-notifications that are sent to one or more user devices.

As used herein, the term “dwell time” refers to an amount of time that elapses between events that occur with respect to a particular location. In some cases, the particular location is a geo-fence. For example, the time that elapses between a user device entering a geo-fence and exiting the geo-fence is the dwell time of the user device within the geo-fence. Additionally or alternatively, the time that elapses between a user device receiving a geo-notification and responding to the geo-notification is the dwell time of the user device for responding to the geo-notification.

As used herein, the term “stay point” refers to a location where a user device remains for an amount of time. For example, the location of a user device is expressed, for example, as a coordinate pair indicating latitude and longitude, a distance and angle from a fixed point (e.g., a radio tower for a mobile telephone/data network), or any other suitable format. A stay point is determined based on a particular location of the user device. In some cases, the stay point has an area (e.g., a radius around the particular location) or a time threshold (e.g., a minimum time that the user device remains). Additionally or alternatively, a stay point that is associated with multiple locations, such as a group of locations within the area of the stay point, is identified by the particular location information (e.g., a latitude/longitude coordinate pair) used to determine the stay point.

The embodiments described herein can improve the operations and capabilities of geo-fence communication system that monitor the positions of user devices and communicate location-specific information to these user devices. For instance, an intelligent geo-notification scheme described above, which adapts triggering notification rules based on prior knowledge about user devices, can utilize network and computing resources more effectively than existing telecommunication systems by personalizing geo-notification communications to particular users. Furthermore, since the aggregation of data from semantically similar locations allows intelligent geo-notification schemes to be generated and applied to semantically similar geo-fences, a personalized geo-fence for a particular area can be designed that effectively allocates relevant resources even if insufficient observation data exists for that particular area. And these intelligent geo-notification schemes offer additional benefits for end users (e.g., reduction in notification fatigue, focus on product content relevant to end users, flexibility in the product content being promoted via geo-notifications, etc.).

Referring now to the drawings, FIG. 1 depicts an example of a geo-fence communication system 100 that is capable of providing geo-notifications to one or more user devices. In some embodiments, geo-fence communication system 100 is operated by an entity that provides online product content to users. The operator provides the online product content to users via multiple channels, such as a website, geo-fence communication system 100, or additional geo-fence communication systems.

The geo-fence communication system 100 includes a control system 110, and one or more notification transmission devices, such as transmission device 120. In some cases, the control system 110 comprises one or more computer systems, such as a server which executes suitable instructions. Additionally or alternatively, control system 110 is implemented as a virtual system, such as a virtual machine or a distributed system.

In some embodiments, geo-fence communication system 100 is capable of accessing (or being accessed by) one or more additional systems. For example, a remote system 170 having user interface 171 is capable of accessing geo-fence communication system 100, such as to provide or receive information. Additionally or alternatively, geo-fence communication system 100 is capable of accessing data stores, such as content interactions database 180 or geo-fence database 185. In some cases, a network (e.g., Internet, a private network) facilitates communications between geo-fence communication system 100 and any of the additional systems 170, 180, or 185.

In some embodiments, geo-fence communication system 100 is capable of communicating with one or more user devices. For example, transmission device 120 communicates with user devices 140, 142, and 144. In some cases, transmission device 120 is located within or near one or more geo-fences, such as geo-fence 130. Additionally or alternatively, transmission device 120 communicates with a user device via one or more intermediaries. Intermediaries include, without limitation, a relay device, an additional transmission device, the Internet, a private network, a local wireless network, a mobile telephone/data network, or any other suitable device or network capable of transmitting a communication. Communications include information describing one or more of the transmission device 120 or a user device, such as a device identification, a location, an identification of a user (e.g., user account), historical device or user activity, a presence of an application installed on the mobile computing device, or other suitable information. In some cases, a communication includes a geo-notification or a response to a geo-notification, as described elsewhere herein.

Based, for example, on the information included in communications with transmission device 120, geo-fence communication system 100 determines whether to provide a geo-notification to one or more of user devices 140, 142, and 144. For example, transmission device 120 receives communications from each of user devices 140, 142, and 144. Based on respective location information in each received communication, geo-fence communication system 100 determines that user devices 140 and 142 are located within a geo-fence 130 that is associated with geo-fence communication system 100. In addition, based on respective application information in each received communication, geo-fence communication system 100 determines that user devices 140 and 144 each have an installed application that is associated with geo-fence communication system 100. Based on these determinations, geo-fence communication system 100 determines that user device 140 is a candidate to receive a geo-notification. Although this example uses the criteria of location and application information to determine the candidate, other criteria (or combinations of criteria) will be apparent to those skilled in the art.

Additionally or alternatively, user devices 140, 142, and 144 are capable of providing information describing activities that occur with the user device, such as entering or exiting geo-fence 130, remaining in an area for a period of time (or “dwelling”), or performing actions related to online product content provided by the operator of geo-fence communication system 100. The performed actions include, for example, browsing to a product or service provided by the operator. In some cases, the user devices 140, 142, and 144 provide the information describing such activities via communications, such as with transmission device 120. Additionally or alternatively, the information is provided via one or more additional computing systems and/or networks.

Based, for example, on the information describing activities of the user device 140, 142, and 144, geo-fence communication system 100 determines a respective trigger notification rule associated with each user device. The trigger notification rule is applied, for example, to the transmission of a geo-notification to the respective user device. For example, a trigger notification rule 111 specifies a particular dwell time associated with the user device 140. In some cases, the particular dwell time is determined based on historical dwell times and actions associated with the user device 140. Based on the trigger notification rule 111, geo-notification 112 is transmitted to user device 140 responsive to user device 140 dwelling within geo-fence 130 for an amount of time equal or greater than the dwell time specified in rule 111.

FIG. 2 is a flow chart depicting an example of a process 200 for modifying how frequently geo-notifications are transmitted to user devices within a geo-fence. In some embodiments, such as described in regards to FIG. 1, a computing device executing a geo-fence communication system implements operations described in FIG. 2, by executing suitable program code. For illustrative purposes, the process 200 is described with reference to the examples depicted in FIG. 1. Other implementations, however, are possible.

At block 210, the process 200 involves identifying geo-fence data for a segment of user devices at geographic locations. For example, a geographic location is included by, served by, or located within one or more geo-fences, such as geo-fence 130. Additionally or alternatively, user devices included in the user segment, such as user device 140, perform interactions with online product content while within the geo-fences.

The geo-fence data is identified, for example, by geo-fence communication system 100. Identification of the geo-fence data is based on, for example, an association between an operator of geo-fence communication system 100 and a geographic location (e.g., a store location), a determination that geo-fence communication system 100 is capable of communicating with user devices within geo-fence 130 (e.g., geo-fence 130 is served by notification transmission device 120), or any other suitable criteria.

In some cases, the geo-fence data is received from one or more additional computing systems, such as from geo-fence database 185. Additionally or alternatively, the geo-fence data describes one or more of a geo-fence location, a geo-fence area or boundary, geographic locations or points of interest within a geo-fence, online product content (e.g., related to an operator of system 100), geo-notifications that are transmitted to a user device while within a geo-fence (e.g., by notification transmission device 120), or other suitable data.

At block 220, the process 200 involves computing an average dwell time for one or more geographic locations described by the identified geo-fence data. The average dwell time is determined, for example, based on dwell times of user devices that interact with online product content while located within a geo-fence that includes one or more of the geographic locations. In some embodiments, a particular dwell time comprises one or both of a time until a user device responds to a geo-notification related to online product content (e.g., responds to a text message or an application message), or a time until a user device browses to an interaction with the online product content in an application (e.g., searches for a product indicated by the content, purchases an indicated product). In some cases, the dwell time includes a response time or browse time that elapses while the user device is within a geo-fence (e.g., the user device performs an interaction after receiving a geo-notification but prior to exiting the geo-fence). Additionally or alternatively, the average dwell time is based on dwell times from multiple user devices performing respective interactions with particular online product content while each user device is located within a particular geo-fence.

At block 230, the process 200 involves computing semantic similarities between the one or more geographic locations described by the identified geo-fence data. The semantic similarities are determined, for example, based on semantic vectors that are associated with geographic locations. In some embodiments, a semantic vector includes representations of points of interest that are located at or near the associated geographic location. For example, the semantic vector includes one or more values indicating a number of nearby places of a certain type (e.g., a first value for a retail type, a second value for a residential type). Additionally or alternatively, the semantic vector includes one or more dimensions indicating places of a certain type, each dimension having multiple values representing respective places of that type. In some embodiments, the semantic vectors are received from an additional computing system, such as geo-fence database 185. Additionally or alternatively, the semantic vectors are determined based on provided information, such as information provided via user interface 175. In some embodiments, operations related to block 230 are omitted.

At block 240, the process 200 involves aggregating the computed average dwell times for the geographic locations. In some embodiments, the aggregation with respect to a particular geographic location is determined based on the computed semantic similarities between the particular location and additional geographic locations. For example, a dwell time for a first location is based on aggregated dwell times for a set of geographic locations that are semantically similar to the first location, above a threshold level of similarity. The threshold level indicates, for example, a size of the set of geographic locations (e.g., the ten most similar locations), or a value of similarity (e.g., 0.6 similarity, 75% similarity), or any other suitable criteria. In some cases, the threshold level is based on provided information, such as information provided via user interface 175. Additionally or alternatively, the provided information indicates one or more particular geographic locations included in the aggregation set.

At block 250, the process 200 involves computing a trigger notification time for a respective geo-fence based on the average dwell times. In some embodiments, the trigger notification time is computed based on the aggregated average dwell times. For example, a trigger notification time for a particular geo-fence is computed based on the aggregated average dwell time for a particular geographic location within the geo-fence. In some cases, the trigger notification time is indicated as an elapsed time (e.g., a delay) before a geo-notification is transmitted to a user device after the user device enters the geo-fence that is associated with the trigger notification time.

At block 260, the process 200 involves applying a trigger notification rule for a respective geo-fence. The trigger notification rule indicates a timing that is derived, for example, from the trigger notification time for the geo-fence. For example, based on a trigger notification rule associated with geo-fence 130, notification transmission device 120 transmits geo-notification 112 to user device 140 after an elapsed time derived from the trigger notification time for geo-fence 130. Additionally or alternatively, if additional user devices that belong the same user segment as user device 140 enter geo-fence 130, geo-notification 112 is transmitted to the additional user devices based on the trigger notification rule associated with geo-fence 130.

In some embodiments, an intelligent geo-notification scheme is determined for multiple geo-fences. For example, a geo-fence communication system determines multiple trigger notification rules for multiple respective geo-fences, based on geo-fence data for multiple geographic locations serviced by the geo-fences. In some cases, an intelligent geo-notification scheme is determined for a set of geo-fences. The set of geo-fences included in the intelligent geo-notification scheme is determined, for example, based on associated geographic locations that are similar (e.g., having a threshold level of semantic similarity), or based on provided information (e.g., information provided via user interface 175).

### User Device Activities and User Segments

In an embodiment, a geo-fence communication system, such as system 100, determines a trigger notification rule, such as rule 111, based on information that describes activities that occur with one or more user devices, or a user segment associated with the user devices, or both. Based on the information that is provided to the geo-fence communication system, the trigger notification rule is personalized for a particular user device included in a particular user segment, with respect to a particular geo-fence and a particular product (e.g., one or more items or services) that are associated with the geo-fence communication system.

For example, a trigger notification rule is determined based on activities such as a user device's dwell time, times that the user device enters or exits a geo-fence, or content interactions performed using the user device. The trigger rule determined based on information about such activities provides, for example, an optimum dwell time that is personalized for geo-notifications sent to the user device. In some cases, providing appropriate geo-notifications after an optimum dwell time reduces notification fatigue of the user, and results in improved user satisfaction, conversion rates, or other business outcomes.

In some embodiments, the dwell time of a particular user device is related to the location of the user device. In some cases, the provided location information changes over time. In some cases, a geo-fence communication system that is capable of determining whether a particular user is remaining in an area or just passing through determines a trigger notification rule to provide (or not provide) geo-notifications that are appropriate to the user's behavior. In addition, performing operations on each individual point of location data (e.g., comparing them to a geo-fence) requires increased computation, decreasing efficient use of available computing resources. Thus, a geo-fence communication system may determine a stay point of a user, such as by comparing received location information to determine if the location points are within an area.

For example, a user device communicates location information to a geo-fence communication system (e.g., via a transmission device), such as by communicating multiple latitude/longitude coordinate pairs. In some cases, the multiple coordinate pairs have different values. For example, the user device may be moving, or may be on a boundary between coordinates, or a system providing the coordinate pairs (e.g., a global positioning system) may provide imprecise information.

In some embodiments, the geo-fence communication system determines a stay point of the user device based on the received location information. For example, geo-fence communication system compares a particular coordinate pair (e.g., an initial pair, a pair that is most frequent) to the other coordinate pairs. Based on the comparison of the multiple coordinate pairs, geo-fence communication system determines that the user device is located at a stay point associated with the particular coordinate pair. In some cases, the geo-fence communication system determines a trigger notification rule based on a location (such as a stay point) of the user device.

Additionally or alternatively, the geo-fence communication system determines a trigger notification rule based on content interactions performed by the user device. For example, a user device is associated with a log of historical content interactions that have occurred after receiving geo-notifications, such as a user responding to a geo-notification (e.g., within an application, via a text message), browsing to content referenced by a geo-notification, searching for content included in a geo-notification, or any other suitable action.

The actions log is accessed by the geo-fence communication system, such as via one or more of the user device, a content interactions database, a storage component within the geo-fence communication system, or any other suitable method.

Additionally or alternatively, the geo-fence communication system determines a trigger notification rule based on geo-fence entry and exit times associated with the user device. For example, a user device is associated with one or more time pairs, each time pair indicating an entry time and an exit time for a geo-fence. The entry/exit time pair include, for example, timestamps indicating when the user device's location moved into (or out of) the geo-fence. The entry/exit time pairs are accessed by the geo-fence communication system, such as via one or more of the user device, a geo-fence database, a storage component within the geo-fence communication system, or any other suitable method.

In some embodiments, the geo-fence communication system determines a trigger notification rule based on a user segment associated with the user device. For example, a geo-fence communication system determines or receives a user segment indicating one or more attributes describing a one or more user devices that are included in the user segment. A user segment includes, for example, attributes such as demographic traits of users (e.g., gender, income, family status) or technical information about mobile computing devices (e.g., device model, operating system, installed applications). Additionally or alternatively, a user segment includes attributes describing previous transactions performed, such as via an application installed on the mobile computing device (e.g., user responds to a certain percentage of geo-notifications, user spends a certain amount of money via the application). In some cases, the described transactions are with entities other than an operator of the geo-fence communication system, such as an affiliated organization. Additionally or alternatively, a user segment includes attributes describing behaviors, such as determining that a user is in a movie theater based on a purchase of a movie ticket and a location. For example, if a particular user segment is associated with people watching a movie in a theater, a trigger notification rule for that segment may require that no geo-notifications be sent until the movie ends.

### Determining Minimum Elapsed Dwell Time of a User Segment

In an embodiment, a geo-fence communication system determines a dwell time for a user device, based on activities associated with the user device of the user device. For example, the geo-fence communication system determines a minimum elapsed dwell time of a user device, for a particular geo-fence and a particular product. In some cases, the minimum elapsed dwell time indicates the minimum time that passed before the user device responded to geo-notifications related to the particular product, while located in the particular geo-fence.

For example, a geo-fence communication system receives information describing multiple user devices' activities regarding multiple products at multiple geo-fences. For convenience, and not by way of limitation, the set of user devices may be referred to as U, the set of geo-fences may be referred to as G, and the set of products may be referred to as P. In some cases, one or more of sets U, G, and P contain information about a single user device, geo-fence, or product, respectively.

Based on the received sets U, G, and P, the geo-fence communication system determines a particular user device's activities regarding a particular product at a particular geo-fence. For convenience, and not by way of limitation, the particular user device, geo-fence, and product is referred to as a user device/geo-fence/product tuple, or with the nomenclature (u, g, p). For example, a user device u is included in set U, a geo-fence g is included in set G, and a product p is included in set P.

In some cases, the received information includes a set of location information of one or more user devices (e.g., respective latitude/longitude coordinate pairs from user devices associated with user devices, such as user device u), a set of entry/exit time pairs of the user device (e.g., at one or more geo-fences, such as geo-fence g), a set of product information (e.g., including the product p), and a set of content interactions (e.g., including interactions performed by the user device u).

Based on the received information, the geo-fence communication system determines a first subset of the content interactions, the first subset including content interactions related to product p performed by user device u. The first subset of content interactions includes, for example, one or both of location information and a timestamp that are associated with each respective content interaction. In addition, based on the first subset of content interactions, the geo-fence communication system determines a second subset of content interactions, the second subset including content interactions related to product p performed by user device u, that occurred within geo-fence g. For example, the geo-fence communication system compares the locations of the geo-fences in G to the location information of the content interactions included in the first subset, and includes content interactions in the second subset based on the location comparison.

Based on the second subset of content interactions, the geo-fence communication system determines a minimum elapsed dwell time for user device u to respond to geo-notifications related to product p while within geo-fence g. For example, the geo-fence communication system compares the timestamp (i.e., t) of each content interaction in the second subset to the entry/exit time pairs for the user device u, and determines a respective entry/exit time pair (i.e., t_{entry} and tₑₓᵢₜ) such that t_{entry}≤t≤tₑₓᵢₜ. In some cases, the value of t_{entry} is subtracted from the value of t. Based on the results of such subtractions, the geo-fence communication system determines an elapsed dwell time for each content interaction that occurred within the geo-fence g. Additionally or alternatively, the geo-fence communication system compares each of the elapsed dwell times, and determines a minimum value (e.g., the shortest time elapsed) for the user device u to respond.

In some embodiments, the geo-fence communication system determines elapsed dwell times for multiple user device/geo-fence/product tuples. For example, the geo-fence communication system determines the minimum elapsed dwell time for every user device u to respond to geo-notifications related to every products p while within every geo-fence g for every (u, g, p) combination available in the sets U, G, and P. Additionally or alternatively, the geo-fence communication system determines the minimum elapsed dwell time for a group of (u, g, p) combinations, such as a group of (u, g, p) associated with user devices included in one or more user segments. For convenience, and not by way of limitation, a set of minimum elapsed dwell times for one or more combinations of (u, g, p) is referred to as Dₘᵢₙ(u, g, p). In some cases, Dₘᵢₙ(u, g, p) is an empty set (e.g., none of the user devices u responded to geo-notifications related to products p while within the geo-fences g).

FIG. 3 is a flow chart depicting an example of a process 300 for determining a minimum elapsed dwell time for a user device responding to geo-notifications related to a product while within a geo-fence. In some embodiments, such as described in regards to FIGS. 1-2, a computing device executing a geo-fence communication system implements operations described in FIG. 3, by executing suitable program code. For illustrative purposes, the process 300 is described with reference to the examples depicted in FIGS. 1-2. Other implementations, however, are possible.

At block 310, the process 300 involves receiving a set of entry/exit time pairs. The enter/exit time pairs describe, for example, times when one or more user devices entered or exited a geo-fence, such as geo-fence 130. In some embodiments, the entry/exit time pairs are received by geo-fence communication system 100. Additionally or alternatively, the entry/exit time pairs are received from an additional computing system, such as content interactions database 180 or geo-fence database 185.

At block 315, the process 300 involves receiving a set of content interactions. The content interactions describe, for example, content interactions performed by the user device regarding one or more products, such as a product that is associated with geo-fence communication system 100. In some cases, the content interactions are received, such as by geo-fence communication system 100, from an additional computing system, such as content interactions database 180.

In some cases, one or both of the set of entry/exit time pairs or the set of content interactions is included with information received by the geo-fence communication system 100. Additionally or alternatively, the set of entry/exit time pairs or the set of content interactions is received from an additional computing system, such as content interactions database 180 or geo-fence database 185. In some cases, the set of entry/exit time pairs is received with (or included in) one or more additional sets of data, such as a set U, G, or P.

At block 320, the process 300 involves determining a location of a content interaction, such as a content interaction of a user device u related to a product p. For example, geo-fence communication system 100 determines a latitude/longitude coordinate pair that is associated with a content interaction. In some embodiments, information indicating the locations of content interactions is included in a set of content interactions received by geo-fence communication system 100, such as described in regards to block 315. Additionally or alternatively, system 100 accesses information indicating the locations. For example, a received set of content interactions includes a reference (e.g., a computer-readable address) to a storage location that is accessible by system 100, such as content interactions database 180.

At block 325, the process 300 involves determining whether the content interaction occurred within a geo-fence, such as geo-fence 130. For example, geo-fence communication system 100 compares a geo-fence 130 to the latitude/longitude coordinate pair associated with a content interaction. In some cases, the location of the content interaction is compared to one of more of the geo-fence's location (e.g., latitude/longitude coordinates), area (e.g., radius, perimeter), or other suitable quality of the geo-fence.

If operations related to block 325 determine that the content interaction occurred outside of the geo-fence, process 300 proceeds to another block, such as block 310, 320, or 350.

If operations related to block 325 determine that the content interaction occurred within the geo-fence, the process 300 determines a time of the content interaction, as depicted in block 330. For example, geo-fence communication system 100 determines a timestamp t that is associated with the content interaction. In some embodiments, information indicating the times of content interactions is included in a received set of content interactions, or is accessed via a reference to a storage location that is accessible by system 100, such as content interactions database 180.

At block 340, the process 300 involves subtracting an entry time from the time of the content interaction. In some embodiments, geo-fence communication system 100 selects the entry time for the subtraction from the received set of entry/exit time pairs, as described with regards to block 310, such that the time of the content interaction is greater than or equal to the entry time and less than or equal to the exit time. Additionally or alternatively, geo-fence communication system 100 subtracts the selected entry time from the timestamp t that is associated with the content interaction, as described with regards to block 330.

In some embodiments, operations related to one or more of blocks 320, 325, 330, or 340 are repeated for each content interaction of user device u related to a product p. In some cases, geo-fence communication system 100 determines a list of subtraction results, or content interaction times associated with an entry/exit time pair, or both. For example, the results of the subtraction operations are stored in a memory storage device associated with system 100.

At block 350, the process 300 involves determining a minimum elapsed time for the user device to perform content interactions regarding the product, while located within the geo-fence. For example, geo-fence communication system 100 compares results of subtractions performed with regards to block 340, and determines the minimum value of the subtraction results.

In some embodiments, operations related to process 300 are repeated for multiple user devices with regards to multiple products or geo-fences. For example, geo-fence communication system 100 repeats process 300 for one or more of user devices 140, 142, or 144, with regards to one or more of geo-fence 130 or additional fences, and with regards to one or more products associated with geo-fence communication system 100.

### Determining Average Dwell Time of a User Segment

In some embodiments, a geo-fence communication system determines an average dwell time for a user segment based on dwell times associated with user devices included in the user segment. For example, a user segment s includes one or more user devices u. In some cases, a particular user segment includes user devices that perform activities regarding a particular product at a particular geo-fence. For convenience, and not by way of limitation, the particular user segment, geo-fence, and product are referred to as a user segment/geo-fence/product tuple, or with the nomenclature (s, g, p).

Additionally or alternatively, the geo-fence communication system determines an average dwell time for a user segment s to respond to geo-notifications related to product p while within geo-fence g. The average dwell time is based, for example, on the minimum elapsed dwell times for the user devices u that are included in the user segment s. The minimum elapsed dwell times for the user devices u included in user segment s are determined as described elsewhere herein, or using any other suitable technique.

In some embodiments, the geo-fence communication system receives information, such as a set Dₘᵢₙ(u, g, p), describing minimum elapsed dwell times for multiple devices users u included in the user segment s of the tuple (s, g, p). Based on the received information, the geo-fence communication system determines an average dwell time for user segment s, such as by calculating a mathematical average value of the minimum elapsed dwell times included in set Dₘᵢₙ(u, g, p).

In some cases, the received information indicates that minimum elapsed dwell times are unknown for (s, g, p). For example, the set Dₘᵢₙ(u, g, p) indicates that no user device u included in user segment s responded to geo-notifications related to product p while within geo-fence g (e.g., set Dₘᵢₙ(u, g, p) is empty). Based on determining that the minimum elapsed dwell times are unknown for (s, g, p), the geo-fence communication system assigns a value for the average dwell time for a user segment s. The assigned value is, for example, zero, a default value, a value indicated by the operator of the geo-fence communication system, or any other suitable value.

In some embodiments, the geo-fence communication system determines average dwell times for multiple user segment/geo-fence/product tuples. For example, the geo-fence communication system determines the average dwell time for every (s, g, p) combination available in the sets U, G, and P. Additionally or alternatively, the geo-fence communication system determines the average dwell time for a group of (s, g, p) combinations, such as a group of (s, g, p) indicated by the operator of the geo-fence communication system. For convenience, and not by way of limitation, a set of average dwell times for one or more combinations of (s, g, p) is referred to as D_{avg}(s, g, p).

FIG. 4 is a flow chart depicting an example of a process 400 for determining an average dwell time for a user segment. In some embodiments, such as described in regards to FIGS. 1-3, a computing device executing a geo-fence communication system implements operations described in FIG. 4, by executing suitable program code. For illustrative purposes, the process 400 is described with reference to the examples depicted in FIGS. 1-3. Other implementations, however, are possible.

At block 410, the process 400 involves receiving information indicating minimum elapsed dwell times for one or more users included in the user segment. For example, the received information includes a set of minimum elapsed dwell times, such as set Dₘᵢₙ(u, g, p). In some cases, geo-fence communication system 100 receives set Dₘᵢₙ(u, g, p) from an additional computing system, such as content interactions database 180 or geo-fence database 185.

Additionally or alternatively, geo-fence communication system 100 determines set Dₘᵢₙ(u, g, p) based on additional received information. For example, geo-fence communication system 100 receives information indicating multiple content interactions related to a particular product within a particular geo-fence, each of the multiple content interactions being performed by a user device included in the user segment. In some cases, the information indicating the multiple content interactions is received from content interaction database 180 or geo-fence database 185. Based on the received information, geo-fence communication system 100 determines a minimum elapsed dwell time for each user device included in the user segment (e.g., for each (u, g, p) tuple that is associated with the (s, g, p) tuple). In some cases, the received information indicates no content interactions related to a particular product within a particular geo-fence (e.g., no user device has performed a content interaction for the product within the geo-fence).

At block 415, the process 400 involves determining whether the information includes values of minimum elapsed dwell times. In some embodiments, the geo-fence communication system 100 determines that the set Dₘᵢₙ(u, g, p) includes values for one or more minimum elapsed dwell times. Alternatively, the geo-fence communication system 100 determines that the set Dₘᵢₙ(u, g, p) is an empty set. For example, system 100 analyzes information indicating content interactions related to a particular product within a particular geo-fence, such as described in regards to block 410. Additionally or alternatively, system 100 receives an indication, such as from content interactions database 180, that no content interactions were performed related to the particular product and geo-fence.

If operations related to block 415 indicate that the received information does not include a value for a minimum elapsed dwell time, the process 400 assigns a value for the average dwell time of the user segment, as depicted in block 420. For example, geo-fence communication system 100 assigns a value of zero, a default value, or a value indicated by the operator of system 100, such as via user interface 171. In some cases, geo-fence communication system 100 assigns the value, responsive to determining that set Dₘᵢₙ(u, g, p) is an empty set.

If operations related to block 415 indicate that the received information includes one or more minimum elapsed dwell times, the process 400 determines an average value of the minimum elapsed dwell times, as depicted in block 430. For example, the minimum elapsed dwell time for each of the user devices that are included in the user segment (e.g., each (u, g, p) tuple associated with the (s, g, p) tuple) are summed and divided by the total number of user devices included in the user segment. In some embodiments, geo-fence communication system 100 performs operations to determine a mathematical average of the minimum elapsed dwell times included in the set Dₘᵢₙ(u, g, p).

At block 440, the process 400 assigns the determined average value to the average dwell time of the user segment. For example, geo-fence communication system 100 assigns the determined average value to the average dwell time of the user segment. In some cases, the assigned value is stored, such as on a memory device associated with geo-fence communication system 100 or on an additional computing system.

In some embodiments, a geo-fence communication system determines a trigger notification rule for a user segment based on the average dwell time for the user segment. For example, if geo-fence communication system 100 determines an average dwell time (e.g., two minutes) for a user segment that includes user device 140, geo-fence communication system 100 determines a trigger notification rule 111 for that user segment. Additionally or alternatively, the geo-fence communication system 100 applies the trigger notification rule 111, such as by delaying (e.g., by two minutes) transmission of geo-notification 112.

### Semantic Similarity of Locations

In some cases, user devices visit only a limited number of locations that have geo-fences. In such cases, a large quantity of user device/product/geo-fence tuples do not have a minimum elapsed dwell time (e.g., the set Dₘᵢₙ(u, g, p) is empty for a large quantity of (u, g, p) tuples). Additionally or alternatively, a large quantity of user segment/product/geo-fence tuples do not have an average dwell time (e.g., the set D_{avg}(s, g, p) is empty or has values of zero for a large quantity of (s, g, p) tuples). In some cases, a set of (u, g, p) or (s, g, p) tuples that has many empty values (e.g., unknown or undefined dwell time values) is considered a sparsely populated data set, or a sparse data set.

Additionally or alternatively, trigger notification rules that are based on a sparse data set do not reflect the preferences or historical activities of user devices that are associated with the sparse data set. Geo-notifications based on such trigger notification rules are not personalized to the user devices, and the user devices may ignore or feel frustrated by such geo-notifications. In some cases, reducing the quantity of (u, g, p) or (s, g, p) tuples with empty values results in an increase of trigger notification rules that are personalized to the user devices. Additionally or alternatively, improving personalization of trigger notification rules reduces notification fatigue and increases relevance of geo-notifications received by the user device.

In some embodiments, a geo-fence communication system enriches a data set, such as by performing operations to reduce a quantity of empty values in the data set. Additionally or alternatively, the data set is enriched based on a semantic similarity of one or more items in the data set. For example, a geo-fence communication system determines a semantic similarity between geo-fences g that are associated with the set D_{avg}(s, g, p). In some cases, a particular geo-fence's semantics (e.g., information representing qualities of the geo-fence) are represented in the form of a semantic vector. For example, the semantic vector indicates a quantity of points of interest for the particular geo-fence. Points of interest include, for example, residential locations, retail locations, schools, restaurants, parks, or other establishments that a user device could visit. Additionally or alternatively, the semantic vector indicates additional qualities of the particular geo-fence, such as population, area, typical weather conditions, or other qualities that describe the geo-fence.

In some cases, the semantic similarity between geo-fences is determined based on a cosine similarity. The cosine similarity is determined, for example, based on similarity between respective semantic vectors of the geo-fences. For convenience, and not by way of limitation, a cosine similarity between a first geo-fence g and an additional geo-fence g′ is referred to with the nomenclature cosine_sim(g, g′).

Additionally or alternatively, a set of semantically similar geo-fences is determined for one or more particular geo-fences based on the determined semantic similarity. For convenience, and not by way of limitation, the set of geo-fences that are most similar to the particular geo-fence g is referred to as the set K(g). In some cases, the number of geo-fences included in the set K(g) is based on a number (e.g., the number k), such as a default number or a number that is provided by the operator of the geo-fence communication system.

In some embodiments, the data set is enriched based on one or more sets of semantically similar geo-fences. For example, a geo-fence communication system determines (or receives) a set D_{avg}(s, g, p), including average dwell times for the user segment s. Additionally or alternatively, for each of the geo-fences g included in the set D_{avg}(s, g, p), the geo-fence communication system determines (or receives) a set of most similar geo-fences K(g). Based on the sets K(g) for each of the geo-fences g, the set D_{avg}(s, g, p) is enriched, such as by Equation 1:

$${𝒟}_{sem} ( s , g , p ) = \frac{{𝒟}_{avg} ( s , g , p ) + {\sum }_{{g}^{′} ∈ 𝒦 ( g )} cosine\_sim ( g , {g}^{′} ) \cdot {𝒟}_{avg} ( s , {g}^{′} , p )}{1 + {\sum }_{{g}^{′} ∈ 𝒦 ( g )} cosine\_sim ( g , {g}^{′} )} \qquad Eq . 1$$

In some cases, the geo-fence communication system determines an enriched set of dwell times for the user segment s. In some cases, the enriched dwell time for each (s, g, p) tuple is determined by Equation 1. For convenience, and not by way of limitation, the enriched set of dwell times is referred to as set Dₛₑₘ(s, g, p). Each (s, g, p) tuple included in the set Dₛₑₘ(s, g, p) has, for example, an associated enriched dwell time.

FIG. 5 is a flow chart depicting an example of a process 500 for determining an enriched dwell time for a user segment. In some embodiments, such as described in regards to FIGS. 1-4, a computing device executing geo-fence communication system implements operations described in FIG. 5, by executing suitable program code. For illustrative purposes, the process 500 is described with reference to the examples depicted in FIGS. 1-4. Other implementations, however, are possible.

At block 510, the process 500 involves receiving information indicating average dwell times for one or more user segment/geo-fence/product tuples. For example, the received information includes a set of average dwell times such as set D_{avg}(s, g, p). In some cases, geo-fence communication system 100 determines the average dwell times, such as described in regards to FIG. 4. Additionally or alternatively, geo-fence communication system 100 receives set D_{avg}(s, g, p) from an additional computing system, such as content interactions database 180 or geo-fence database 185.

At block 520, the process 500 involves determining a similarity between a particular geo-fence included in the received information and an additional geo-fence. For example, geo-fence communication system 100 determines a cosine similarity between a particular geo-fence g and an additional geo-fence g′. Additionally or alternatively, the cosine similarity is based on semantic vectors associated with each respective geo-fence. In some embodiments, operations related to block 520 are repeated for each additional geo-fence that is included in the received information.

At block 530, the process 500 involves determining one or more additional geo-fences that are most similar to the particular geo-fence. For example, a set of similar geo-fences is determined based on an indicated number of geo-fences, such as the k geo-fences that are most similar to the particular geo-fence. Additionally or alternatively, a set of similar geo-fences is determined based on a threshold level of similarity, such as all geo-fences that have a 75% similarity or greater with respect to the particular geo-fence. In some embodiments, the geo-fence communication system 100 determines a set K(g), which includes the k additional geo-fences g′ that are most similar to the particular geo-fence g. The numeric value of k is based on, for example, information received from user interface 175, or a default value stored in a memory device associated with system 100.

At block 540, the process 500 involves determining an enriched dwell time for each of the user segment/geo-fence/product tuples. For example, for a particular tuple having a particular geo-fence g, the cosine similarities of each geo-fence g′ in the set of similar geo-fences is multiplied by the average dwell time for the respective similar geo-fence g′, and the results of the multiplications are summed (e.g., for all geo-fences g′ in set K(g)). Furthermore, the result of the summation is added to the average dwell time for the particular geo-fence g, and the result is divided by a summation of the cosine similarities of each geo-fence g′ added to a constant (e.g., as in Equation 1). Additionally or alternatively, the enriched dwell time for a particular (s, g, p) tuple is included in a set Dₛₑₘ(s, g, p). In some embodiments, geo-fence communication system 100 determines, such as performing operations based on Equation 1, a set Dₛₑₘ(s, g, p) that includes a semantically enriched dwell time for each (s, g, p) tuple. Additionally or alternatively, system 100 receives one or more semantically enriched dwell times from an additional computing system.

### Generating Trigger Notification Rules

In some embodiments, a geo-fence communication system generates a trigger notification rule based on enriched dwell times, such as enriched dwell times included in the set Dₛₑₘ(s, g, p). For example, the geo-fence communication system generates a trigger notification rule for every (s, g, p) tuple that is associated with the set Dₛₑₘ(s, g, p). A particular trigger notification rule for a particular (s, g, p) tuple is based on the particular enriched dwell time for the tuple. For example, the particular trigger notification rule indicates a delay based on the particular enriched dwell time. In some cases, a geo-fence communication system that applies the particular trigger notification rule allows the indicated delay to pass before sending a geo-notification related to product p to a user device included in the user segment s, while the user device is located within the geo-fence g.

FIG. 6 depicts an example of a geo-fence communication system 600 that is capable of determining trigger notification rules based on semantic similarities between geo-fences. The geo-fence communication system 600 includes a control system 610, and one or more notification transmission devices, such as transmission device 620. Additionally or alternatively, the geo-fence communication system 600 is associated with multiple geo-fences, such as geo-fences 630 and 635. In some cases, the geo-fence communication system 600 is associated with an operator, or with one or more additional computing systems, such as described in regards to FIG. 1.

In some embodiments, geo-fence communication system 600 is capable of communicating with one or more user devices. For example, transmission device 620 communicates with user devices 640, 642, and 644. In some cases, the user devices 640, 642, and 644 are included in a user segment, such as user segment 640. The user devices 640, 642, and 644 perform activities with regards to geo-fence 630. The activities include, for example, entering or exiting the geo-fence 630, dwell times associated with geo-fence 630, and content interactions with one or more products, such as product 690, associated with geo-fence communication system 600.

In some embodiments, geo-fence communication system 600 receives or determines information describing the activities of user devices 640, 642, and 644 with regards to geo-fence 630 and product 690. For example, geo-fence communication system 600 receives one or more of entry/exit time pairs, location coordinates, content interactions, minimum elapsed dwell times, average dwell times, or enriched dwell times. In some cases, geo-fence communication system 600 determines one or more of sets Dₘᵢₙ(u, g, p), D_{avg}(s, g, p), K(g), or Dₛₑₘ(s, g, p) as described with regards to FIGS. 1-5.

Additionally or alternatively, geo-fence communication system 600 generates trigger notification rules associated with one or more (s, g, p) tuples. For example, geo-fence communication system 600 generates a first trigger notification rule 611 associated with the user segment including user devices 640, 642, and 644; product 690; and geo-fence 630. The trigger notification rule 611 indicates a first optimal dwell time for geo-notifications related to product 690, sent to user devices 640, 642, and 644, within geo-fence 630. In some cases, trigger notification rule 611 is generated based in part on the average dwell time of the user segment, such as indicated in set D_{avg}(s, g, p).

In some embodiments, geo-fence communication system 600 generates a second trigger notification rule 615 associated with the user segment including user devices 640, 642, and 644; product 690; and geo-fence 635. For example, trigger notification rule 615 is determined based in part on a semantic similarity between geo-fence 630 and geo-fence 635. The trigger notification rule 615 indicates a second optimal dwell time for geo-notifications related to product 690, sent to the user devices 640, 642, and 644, within geo-fence 635. In some cases, trigger notification rule 615 is generated based in part on the enriched dwell time of the user segment, such as indicated in set Dₛₑₘ(s, g, p).

In some cases, geo-fence communication system 600 applies one or more of trigger rules 611 or 615 to user devices in communication with transmission device 620. For example, geo-notification 612 is transmitted according to information included in trigger notification rule 611, such as based on the first optimal dwell time. Additionally or alternatively, geo-notification 616 is transmitted according to information included in trigger notification rule 615. For example, if user device 644 moves from geo-fence 630 to geo-fence 635, as indicated by user device 644a, geo-notification 616 is transmitted based on the second optimal dwell time.

In some embodiments, the trigger notification rule is generated based on a comparison between an enriched dwell time and a threshold. For example, a geo-fence communication system receives a threshold dwell time indicating a minimum (or maximum) time value related to geo-notifications provided by the system. The threshold dwell time is received, for example, from an operator of the geo-fence communication system, or from a default value. Additionally or alternatively, the geo-fence communication system compares the threshold dwell time to the enriched dwell time. In some cases, if the value of the threshold dwell time is greater than the value of the enriched dwell time, the trigger notification rule indicates a delay equal or greater than the threshold (e.g., a minimum threshold delay before sending a geo-notification). Additionally or alternatively, if the value of the threshold dwell time is less than the value of the enriched dwell time, the trigger notification rule indicates a delay equal or less than the threshold (e.g. a maximum threshold delay before sending a geo-notification).

FIG. 7 is a flow chart depicting an example of a process 700 for generating a trigger notification rule for a user segment/geo-fence/product tuple, based on dwell time. In some cases, the trigger notification rule is generated based on an enriched dwell time. In some embodiments, such as described in regards to FIGS. 1-6, a computing device executing a geo-fence communication system implements operations described in FIG. 7, by executing suitable program code. For illustrative purposes, the process 700 is described with reference to the examples depicted in FIGS. 1-6. Other implementations, however, are possible.

At block 710, the process 700 involves receiving information indicating an enriched dwell time for a user segment/geo-fence/product tuple. For example, the enriched dwell time is included in a set of enriched dwell times, such as set Dₛₑₘ(s, g, p). In some cases, geo-fence communication system 100 determines the enriched dwell times, such as described in regards to FIG. 5. Additionally or alternatively, geo-fence communication system 100 receives set Dₛₑₘ(s, g, p) from an additional computing system, such as content interactions database 180 or geo-fence database 185.

At block 720, the process 700 involves receiving a threshold dwell time. In some cases, the threshold dwell time indicates a minimum delay related to sending out a geo-notification. For example, a threshold dwell time has a value of fifteen seconds, indicating that geo-notifications should not be transmitted until a user device has dwelled in a geo-fence for at least fifteen seconds. In some embodiments, the threshold dwell time is received by geo-fence communication system 100. For example, system 100 accesses a default threshold dwell time, or a threshold dwell time is based on information from the operator of system 100, such as information received via user interface 171.

At block 725, the process 700 involves determining whether the enriched dwell time is greater than the threshold dwell time. For example, geo-fence communication system 100 compares the value of the enriched all time to the value of the threshold dwell time.

If operations related to block 725 indicate that the enriched dwell time is greater than the threshold dwell time, the process 700 assigns the value of the enriched dwell time to an optimum dwell time (e.g., an optimum minimum dwell time), as depicted in block 730. Alternatively, if operations related to block 725 indicate that the threshold dwell time is greater than the enriched dwell time, the process 700 assigns the value of the threshold dwell time to the optimum dwell time, as depicted in block 740.

At block 750, the process 700 involves generating a trigger notification rule based on the optimum dwell time. For example, geo-fence communication system 100 generates a trigger notification rule 111 based on an optimum dwell time for user device 140, and provides a geo-notification 112 after the optimum dwell time has elapsed.

In some embodiments, some operations related to blocks 720, 725, 730, and 740 are repeated for additional threshold dwell times. For example, a second threshold dwell time indicates a maximum delay related to sending out a geo-notification. In such cases, operations related to block 725 determine the greater of the second threshold. Additionally or alternatively, operations related to one or more of blocks 730 or 740 assign the determined greater value to a second optimum dwell time (e.g., an optimum maximum dwell time).

### System Components

Any suitable computing system or group of computing systems can be used for performing the operations described herein. For example, FIG. 8 is a block diagram depicting a geo-fence communication system, according to certain embodiments.

The depicted example of a computing system 801 includes one or more processors 802 communicatively coupled to one or more memory devices 804. The processor 802 executes computer-executable program code or accesses information stored in the memory device 804. Examples of processor 802 include a microprocessor, an application-specific integrated circuit (“ASIC”), a field-programmable gate array (“FPGA”), or other suitable processing device. The processor 802 can include any number of processing devices, including one.

The memory device 804 includes any suitable non-transitory computer-readable medium for storing one or more of a control system, such as control system 210; the notification transmission device, such as transmission device 220; trigger notification rules, such as rules 211 or 215; and other received or determined values, data sets, or data objects. In some embodiments, the notification transmission device is resident on an additional device of an additional computing system. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 801 may also include a number of external or internal devices such as input or output devices. For example, the computing system 801 is shown with an input/output (“I/O”) interface 808 that can receive input from input devices or provide output to output devices. A bus 806 can also be included in the computing system 801. The bus 806 can communicatively couple one or more components of the computing system 801.

The computing system 801 executes program code that configures the processor 802 to perform one or more of the operations described above with respect to FIGS. 1-7. The program code includes operations related to, for example, one or more of the control system 210, the notification transmission device 220, trigger notification rules 211 or 215, or other suitable applications or memory structures that perform one or more operations described herein. The program code may be resident in the memory device 804 or any suitable computer-readable medium and may be executed by the processor 802 or any other suitable processor. In some embodiments, the program code described above, are stored in the memory device 804, as depicted in FIG. 8. In additional or alternative embodiments, one or more of the control system 210, the notification transmission device 220, trigger notification rules 211 or 215, and the program code described above are stored in one or more memory devices accessible via a data network, such as a memory device accessible via a cloud service.

The computing system 801 depicted in FIG. 8 also includes at least one network interface 810. The network interface 810 includes any device or group of devices suitable for establishing a wired or wireless data connection to one or more data networks 812. Non-limiting examples of the network interface 810 include an Ethernet network adapter, a modem, and/or the like. A remote system 815 is connected to the computing system 801 via network 812, and remote system 815 can perform some of the operations described herein, such as storing color images or extracted patches. The computing system 801 is able to communicate with one or more of the remote system 170, content interactions database 180, geo-fence database 185, or additional notification transmission devices using the network interface 810. Although FIG. 8 depicts content interactions database 180 and geo-fence database 185 as connected to computing system 801 via the networks 812, other embodiments are possible, including content interactions database 180 and geo-fence database 185 running as a program in the memory 804 of computing device 801.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method comprising:
identifying, by a processing device, geo-fence data for a user segment, the geo-fence data comprising records of interactions with online product content via a mobile computing device that occurred within geo-fences that service geographic locations; and
modifying, by the processing device, how frequently notification transmission devices transmit notifications within the geo-fences by performing operations comprising:
computing average dwell times for the geographic locations, respectively, wherein a dwell time comprises at least one of (i) a response time that is a duration until the mobile computing device responds to a notification within one of the geo-fences that identifies the online product content or (ii) a browse time that is a duration until an interaction with the online product content via the mobile application and within one of the geo-fences,
computing semantic similarities for the geographic locations, respectively, wherein a semantic similarity between a pair of geographic locations is computed based on a corresponding pair of semantic vectors for the geographic locations, wherein each semantic vector includes dimensions representing points of interest located within a threshold distance of a respective geographic location,
aggregating the average dwell times based on the semantic similarities for the geographic locations having a threshold similarity,
computing, from the aggregated average dwell times, a trigger notification time for the user segment at each respective geo-fence, and
applying a trigger notification rule to each respective geo-fence that causes the notification transmission devices to transmit, with a timing derived from the trigger notification time, subsequent notifications to mobile computing devices associated with users that correspond to the user segment.

2. The method of claim 1, wherein the user segment is comprised of multiple users that share an attribute, wherein the attribute is one of a demographic trait, technical information about the mobile computing device, or a pattern of user actions.

3. The method of claim 1, wherein the records of interactions describe one of a response to a notification received by the mobile computing device, or an activity performed within an application associated with the online product content, the application executed on the mobile computing device.

4. The method of claim 1, wherein the semantic similarity is computed based on a cosine similarity between the pair of geographic locations.

5. The method of claim 1, wherein the timing derived from the trigger notification time is one of either the average dwell time or an indicated threshold time.

6. The method of claim 1, wherein a respective average dwell time for a respective geographic location is computed based on a minimum elapsed dwell time for a user at the geographic location, wherein the user is included in the user segment.

7. The method of claim 6, wherein the respective geographic location is a stay point located within a respective geo-fence.

8. A non-transitory computer-readable medium embodying program code for modifying how frequently notification transmission devices transmit notifications within geo-fences, the program code comprising instructions which, when executed by a processor, cause the processor to perform operations comprising:
identifying geo-fence data for a user segment, the geo-fence data comprising records of interactions with online product content via a mobile computing device that occurred within geo-fences that service geographic locations; and
modifying, by the processing device, how frequently notification transmission devices transmit notifications within the geo-fences by performing operations comprising:
computing average dwell times for the geographic locations, respectively, wherein a dwell time comprises at least one of (i) a response time that is a duration until the mobile computing device responds to a notification within one of the geo-fences that identifies the online product content or (ii) a browse time that is a duration until an interaction with the online product content via the mobile application and within one of the geo-fences,
computing semantic similarities for the geographic locations, respectively, wherein a semantic similarity between a pair of geographic locations is computed based on a corresponding pair of semantic vectors for the geographic locations, wherein each semantic vector includes dimensions representing points of interest located within a threshold distance of a respective geographic location,
aggregating the average dwell times based on the semantic similarities for the geographic locations having a threshold similarity,
computing, from the aggregated average dwell times, a trigger notification time for the user segment at each respective geo-fence, and
applying a trigger notification rule to each respective geo-fence that causes the notification transmission devices to transmit, with a timing derived from the trigger notification time, subsequent notifications to mobile computing devices associated with users that correspond to the user segment.

9. The non-transitory computer-readable medium of claim 8, wherein the user segment is comprised of multiple users that share an attribute, wherein the attribute is one of a demographic trait, technical information about the mobile computing device, or a pattern of user actions.

10. The non-transitory computer-readable medium of claim 8, wherein the records of interactions describe one of a response to a notification received by the mobile computing device, or an activity performed within an application associated with the online product content, the application executed on the mobile computing device.

11. The non-transitory computer-readable medium of claim 8, wherein the semantic similarity is computed based on a cosine similarity between the pair of geographic locations.

12. The non-transitory computer-readable medium of claim 8, wherein the timing derived from the trigger notification time is one of either the average dwell time or an indicated threshold time.

13. The non-transitory computer-readable medium of claim 8, wherein a respective average dwell time for a respective geographic location is computed based on a minimum elapsed dwell time for a user at the geographic location, wherein the user is included in the user segment.

14. The non-transitory computer-readable medium of claim 13, wherein the respective geographic location is a stay point located within a respective geo-fence.

15. A system for modifying how frequently notification transmission devices transmit notifications within geo-fences, the system comprising:
a means for identifying geo-fence data for a user segment, the geo-fence data comprising records of interactions with online product content via a mobile computing device that occurred within geo-fences that service geographic locations; and
a means for modifying how frequently notification transmission devices transmit notifications within the geo-fences, comprising:
computing average dwell times for the geographic locations, respectively, wherein a dwell time comprises at least one of (i) a response time that is a duration until the mobile computing device responds to a notification within one of the geo-fences that identifies the online product content or (ii) a browse time that is a duration until an interaction with the online product content via the mobile application and within one of the geo-fences,
computing semantic similarities for the geographic locations, respectively, wherein a semantic similarity between a pair of geographic locations is computed based on a corresponding pair of semantic vectors for the geographic locations, wherein each semantic vector includes dimensions representing points of interest located within a threshold distance of a respective geographic location,
aggregating the average dwell times based on the semantic similarities for the geographic locations having a threshold similarity,
computing, from the aggregated average dwell times, a trigger notification time for the user segment at each respective geo-fence, and
applying a trigger notification rule to each respective geo-fence that causes the notification transmission devices to transmit, with a timing derived from the trigger notification time, subsequent notifications to mobile computing devices associated with users that correspond to the user segment.

16. The system of claim 15, wherein the user segment is comprised of multiple users that share an attribute, wherein the attribute is one of a demographic trait, technical information about the mobile computing device, or a pattern of user actions.

17. The system of claim 15, wherein the records of interactions describe one of a response to a notification received by the mobile computing device, or an activity performed within an application associated with the online product content, the application executed on the mobile computing device.

18. The system of claim 15, wherein the semantic similarity is computed based on a cosine similarity between the pair of geographic locations.

19. The system of claim 15, wherein the timing derived from the trigger notification time is one of either the average dwell time or an indicated threshold time.

20. The system of claim 15, wherein a respective average dwell time for a respective geographic location is computed based on a minimum elapsed dwell time for a user at a stay point located within a respective geo-fence, wherein the user is included in the user segment.
